(19) United States
(12) Patent Application Publication
(10) Pub. No.: US 2012/0067012 A1
(43) Pub. Date: Mar. 22, 2012

(54) System and Apparatus for Extracting Contaminants from Flue Gas

(76) Inventor: A. Glen Edwards, Comanche, OK (US)

(21) Appl. No.: 13/237,932

(22) Filed: Sep. 20, 2011

Related U.S. Application Data
(60) Provisional application No. 61/403,645, filed on Sep. 20, 2010.

(51) Int. Cl. B01D 45/08

(52) U.S. Cl. 55/342

(57) ABSTRACT

A particulate extraction system is disclosed, which passively removes particulates and some acids from a flue gas by forcing a series of volume and/or temperature changes on the flue gas. The system may have an interconnected series of chambers of varying cross-sectional sizes to effect the changes in volume. The system may also be uninsulated to allow the flue gas to be cooled as by radiation.

### CROSS-REFERENCES TO RELATED APPLICATIONS

This application claims the benefit of U.S. Provisional Patent Application Ser. No. 61/61/403,645, entitled “Specifications for Improved Huff and Puff Particulate Extraction Unit,” filed on Sep. 20, 2010, the contents of which are hereby incorporated by reference in their entirety.

### BACKGROUND OF THE INVENTION

The present invention generally relates to methods and devices for removing particulates and contaminants from heated exhaust or flue gas.

Most all carbon burning devices such as incinerators, power plants, and engines produce undesirable products of combustion that are discharged to the air. Such emissions are termed flue gas, i.e the gas exiting to the atmosphere via a flue, which may be a pipe or other kind of channel for conveying exhaust gases from a combustion process occurring in a fireplace, oven, furnace, engine, boiler, or steam generator. Quite often, the flue gas refers to the combustion exhaust gas produced at power plants. Its composition depends on what is being burned, but it will usually consist of mostly nitrogen (typically more than two-thirds) derived from the combustion air, carbon dioxide (CO2), and water vapor, as well as excess oxygen (also derived from the combustion air). It may further contain a small percentage of a number of pollutants, such as particulate matter, carbon monoxide, nitrogen oxides, and sulfur oxides.

At power plants, flue gas is often treated with a series of chemical processes and scrubbers, which remove pollutants. Electrostatic precipitators or fabric filters may remove particulate matter and flue gas desulfurization may capture the sulfur dioxide produced by burning fossil fuels, particularly coal. Oxides of nitrogen may be treated either by modifications to the combustion process to prevent their formation, or by high temperature or catalytic reaction with ammonia or urea. In either case, the aim is to produce nitrogen gas, rather than nitrogen oxides. In the US, there is a rapid deployment of technologies to remove mercury from flue gas—typically by adsorption on sorbents or by capture in inert solids as part of the flue gas desulfurization product.

There are a range of emerging technologies for removing these pollutants. As yet, there is very little performance data available from large-scale industrial applications of such technologies, and none has achieved significant penetration of the enormous worldwide market. Furthermore, they generally involve the use of additional power sources to achieve the removal of pollutants, e.g. electrostatic precipitators; supply chemicals that must be replenished; expensive catalytic devices; reburn chambers; and the like.

A more passive means is needed to capture these undesirable elements, such as particulates, acids, heavy metals, furans, and dioxins. U.S. Pat. No. 5,222,446, issued to Edwards, et. al, disclosed a particulate extraction device that simply used a single expansion of the exhaust gas combined with a tortuous path and cooling the gases. This system proved quite effective at removing particulate, heavy metals, and acids. However, the system was large and cumbersome and did not lend itself to mobile applications.

As can be seen, there is a need for a passive contaminant extraction device that is smaller, more manageable than heretofore.

### SUMMARY OF THE INVENTION

The invention includes a particulate extraction apparatus for removing contaminants from a flue gas flowing in a direction from upstream to downstream, where the apparatus comprises a plurality of chambers, each chamber having an inlet port, an outlet port, and at least one adjacent chamber, a first selected chamber being designated as an initial chamber to receive the flow of flue gas, a second selected chamber being designated as a final chamber to exhaust the flow of flue gas from the plurality of chambers, the chambers arranged in an ordered sequence with the initial chamber upstream from all other chambers and the final chamber downstream from all other chambers, the outlet of each chamber that is not the final chamber being in communication with the inlet of an adjacent downstream chamber.

The invention also includes a particulate extraction apparatus comprising: one or more sections stacked vertically, each section containing a leftmost chamber and a rightmost chamber that do not communicate with each other, each chamber in the section having a top side, a bottom side, a port in the top side, and a port in the bottom side, the uppermost section receiving a stream of flue gas through the top side port of the leftmost chamber, the uppermost section delivering the stream of flue gas out of the top side port of the rightmost chamber; and a containment vessel supporting the stacked sections with the bottom sides of the chambers in the lowest section in direct contact with a containment vessel top side, the containment vessel top side having a first containment vessel port in communication with the bottom side port of the leftmost chamber of the lowest section, the containment vessel top side having a second containment vessel port in communication with the bottom side port of the rightmost chamber of the lowest section. The apparatus conducts downwardly the stream of flue gas entering the top side port of the leftmost chamber of the upper section through all the leftmost chambers sequentially until the stream enters the containment vessel, horizontally from the first containment vessel port to the second containment vessel port, and thence upwardly through the rightmost chambers of each section sequentially to exit through the top side port of the rightmost chamber in the uppermost section.

These and other features, aspects and advantages of the present invention will become better understood with reference to the following drawings, description and claims.

### BRIEF DESCRIPTION OF THE DRAWINGS

FIG. 1 shows a perspective drawing of a particulate extraction device, according to an embodiment of the invention;

FIG. 2 shows a cut away side view of the internal construction of a particulate extraction device, according to an embodiment of the invention;

FIG. 3 shows the construction of a first 50% velocity chamber, according to an embodiment of the invention;

FIG. 4 shows the construction of a first 33.3% velocity chamber according to an embodiment of the invention;

FIG. 5 shows the construction of a 20% velocity chamber according to an embodiment of the invention;

FIG. 6 shows the construction of a second 50% velocity chamber according to an embodiment of the invention;

FIG. 7 shows the construction of a second 33.3% velocity chamber, according to an embodiment of the invention;

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the current invention includes systems, devices, and methods for passively removing contaminants and particulates from a flue gas being emitted from a combustion process. To process the same volume of exhaust gases, the present invention requires approximately one-third the footprint of the unit described in U.S. Pat. No. 5,222,446. The present invention achieves removal of contaminates by a combination of expansion/contraction of the flue gas and condensation by condensation. It provides multiple expansions and contractions of the exhaust gases, whereas the prior unit only expanded the gases once and then contracted the gases at the exhaust port. The prior art invention could also be composed of a refractory substance which was heavy and cumbersome, whereas the present invention allows heat from the flue gas to be radiated through the walls of the device to the atmosphere to achieve condensation through reduction of temperature. This reduction in weight allows the current invention to be used in a broader number of applications.

The invention may be adapted for use for any combustion process requiring the cleaning of contaminants from exhaust gases. Such uses may include coal fired power plants, incinerators, and processes involving diesel engines, such as marine diesel engines, diesel locomotives, diesel trucks, diesel engine powered generators, diesel powered compressors, and the like. One particular application may involve installation on the exhaust systems of large, marine, diesel powered vessels such as tug boats, large ships, and the like. A prototype unit has been heretofore installed on a tug boat for transporting barges along navigatable rivers and has proved to effectively reduce toxic emissions from the diesel engine exhaust. The invention can also be used for dust collection such as cement bulk systems to collect dry cement particles, rock crushers to collect fines produced by the crushing process, asphalt plants, parts blasters, steel mills, smelters, chemical plants, grain elevators, feed mills, sugar refiners/mills, saw mills, cabinet shops, woodworking shops, furniture makers, and any other process that releases particles into the ambient air.

The present invention may be embodied as a modular device that uses gas velocity changes to create increased slip velocity and temperature reduction to remove particulates, acids, heavy metals, furans, dioxins, and other substances that tend to cling to the particulates. The invention includes a plurality of chambers to decrease and increase the gas velocity in a so-called “huff and puff” manner. In the embodiment shown, the huff and puff sequence is as follows: decrease velocity to 50% of original, increase velocity to 100% of original, decrease velocity to 33.33% of original, increase velocity to 100% of original, decrease velocity to 20% of original, increase velocity to 100% of original, decrease velocity to 50% of original, increase velocity to 100% of original, decrease velocity to 33.33% or original, and increase velocity to 100% original. Where space permits, additional expansion, thus greater velocity reductions can be obtained, but reducing the velocity to approximately 25% of the original seems to be a preferable amount at this time.

Since this device is not insulated, the gases will cool from an inlet temperature of several hundred degrees to 100°-150° Fahrenheit upon exit from the apparatus. This causes any items that will liquefy at temperatures between inlet temperature and 150° F. to do so. Thus, most acids such as sulfuric acid, hydrogen chloride acid, etc., will liquefy and be trapped in the lower areas of the unit by gravitational action. This may help eliminate the role that incinerators, power plants, etc. play in the production of acid rain. Also, removal of these emissions may further reduce the volume of material passing through subsequent chambers and finally through the exhaust port. These reductions will be discussed later.

The invention relies upon the concept of slip velocity. Slip velocity is defined as the difference between the particle speed and the gas speed. At lower gas velocities, entrained particulates tend to fall out of their gas and become trapped in the lower portion of the unit because of increased slip velocity. Accordingly, horizontal surfaces may be replaced within the unit with angled surfaces. This may permit particulates and liquids to fall to the bottom of the apparatus where they may be concentrated, drained, periodically removed from the apparatus, and taken to an appropriate disposal site.

As seen by reviewing the formula below, other factors may affect slip velocity. Particulate diameter is a direct contributor to slip velocity. As the difference between particulate density and gas density increases, slip velocity increases. To a lesser degree, as the gas density and gas viscosity increase, then the slip velocity also increases.

Slip velocity SV may be defined by the following formula:

SV=[(175)·(PD)·(7.48·(PW−GW))^{2/3}]÷[(GW)^{1/3}%·(CP)^{1/3}]

where:

SV=slip velocity, ft/min

175=Constant

PD=Particulate Diameter, inches

7.48=Constant

PW=Particulate density, lb/cu ft

GW=Gas Density, lb/cu ft

CP=Gas Viscosity, centipoises

Since these factors are controlled by the combustion process and not the present invention, their effect is not included in the following information but rather is assumed to be constant. Only the factors that are directly affected by the invention are considered, namely, gas velocity and temperature reduction.

The exhaust gas or flue gas may contain a variety of components, but a typical flue gas composition is shown in Table 1 as it enters and exits a particulate extraction unit constructed according to an embodiment of the invention. As can be seen in Table 1, the unit may remove more than 90% of the acids and water vapor, thus creating, in this case a reduction in the total volume to 76% of the original, or a reduction of 24%. Typically this reduction ranges from 20% to 30%, depending on the make-up of the gas stream.

TABLE 1
Typical Exhaust Gases Entering and Exiting Apparatus

| | Total Entering Unit | Total Exiting Unit |
|---|---|---|
| Product | (ft³ of product/hour) | (ft³ of product/hour) |
| CO₂ | 159749.34 | 150749.34 |
| CO | 1437744.1 | 1437744.06 |
| N₂ | 6649001.300 | 6649001.312 |
| SO₂ | 1865.325 | 1.865325 |
| H₂O | 2602580.1 | 2602.580122 |
| Cl | 0 | 0 |
| Fl | 0 | 0 |
| Excess O₂ | 0 | 0 |
| Inorganics | 0 | 0 |
| TOTAL | 10850940 | 8249099.158 |

As the flue gases pass through the particulate extraction apparatus, they may cool from about 600° F. to about 140° F. This cooling may be accompanied by a reduction in gas volume, i.e. a contraction of the gases. Assuming the gases follow the perfect gas laws, then the reduction can be calculated as follows:

(P1*V1)/T1=(P2*V2)/T2

where:

P1=Pressure at entrance, psi

V1=Volume at entrance, ft³

T1=Temperature at entrance, ° R.=600+459.67=1059.67° R

P2=Pressure at exit, psi

V2=Volume at exit, ft³

T2=Temperature at exit, ° R.=140+459.67=599.67° R

Typically, P1=P2, therefore, our equation becomes:

(V1÷T1)=(V2÷T2)

or:

V2=V1*(T2÷T1)

V2=V1*(599.67÷1059.67)

V2=0.5659*V1

(0.76*0.57)=0.43=43% of the original volume

This decrease in velocity coupled with the volume expansions created by the device will remove up to 99.9999% of the particulates from most exhaust gas streams.

To accomplish this goal of removing particulates through control of velocity and volume (density) of the flue gas, the invention may comprise a series of chambers constructed in such a way as to vary the density of the flue gases (by allowing the flue gases to expand and contract) while at the same time varying the flue gas velocity. Entrained particulates may thus be released from the gas stream and collected for removal. Furthermore, the walls of the chambers may provide surfaces to condense water vapor in the flue gas stream that may have combined with water vapor to produce sulfuric and/or nitric acids, and collect these substances for removal as well. It has been found that collection of these particulates and acidic compounds may be facilitated by gravity.

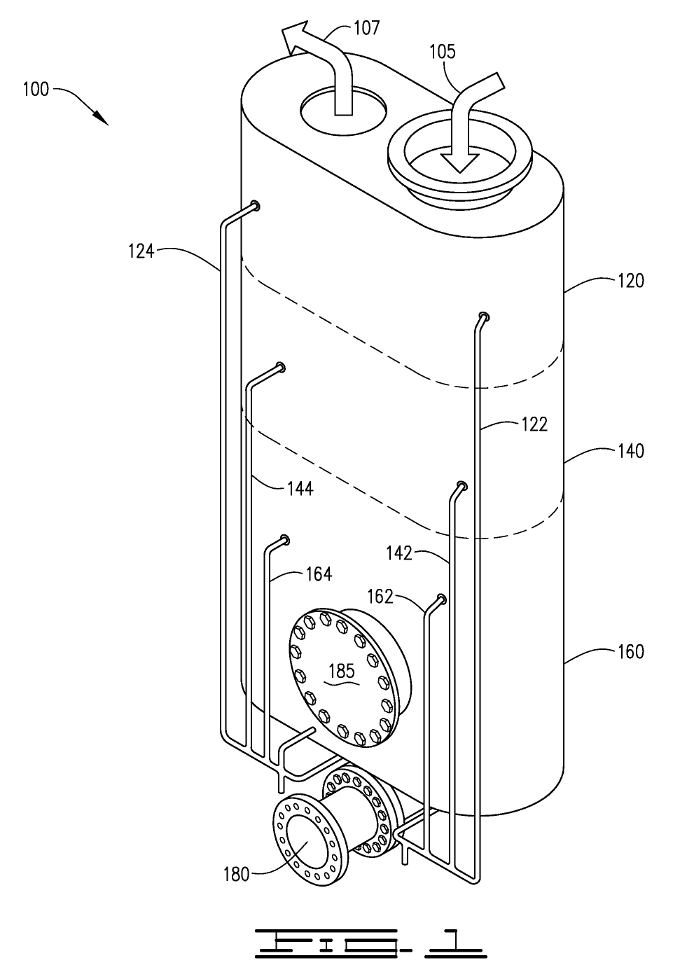

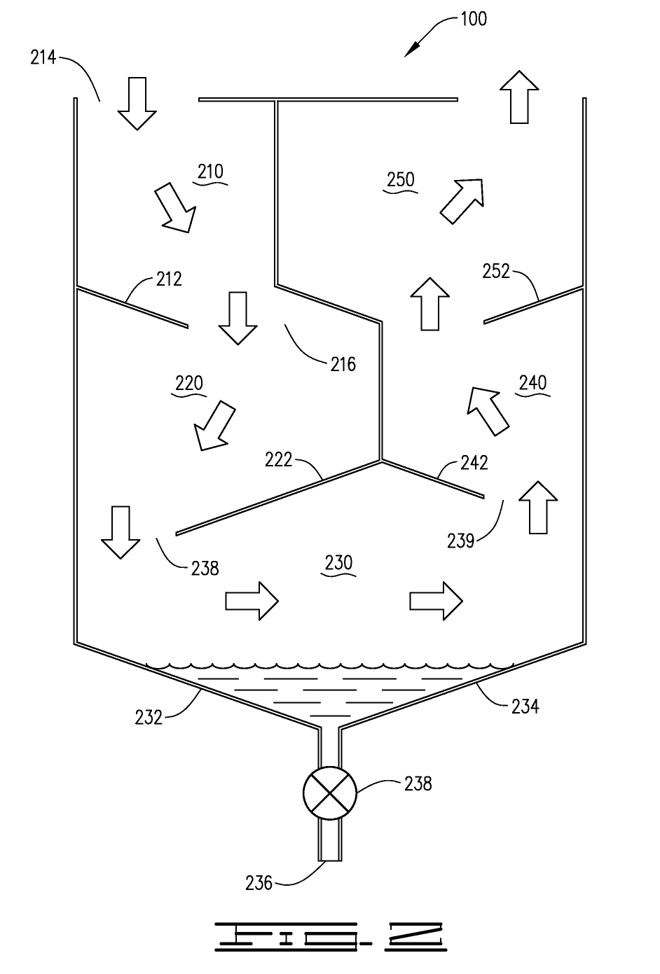

In an embodiment of the invention, a flow of flue gas may enter the top of an apparatus such as the apparatus shown in FIG. 1, which conducts the flue gas through a series of differently sized chambers, so that removed contaminants may fall through the apparatus into a containment vessel at the bottom of the apparatus for waste removal. Preferably the flue gas may enter the top of the apparatus to flow downwardly through one or more chambers, through the containment vessel, and upwardly back through another series of chambers to exit the apparatus at its upper portion. An embodiment of such a gas flow may be seen in FIG. 2, which is a sectional view of the interior of the apparatus shown in FIG. 1. It should be noted that flue gases may be removed from a lower portion of the apparatus without including a second series of chambers downstream from the containment vessel, without departing from the scope of the invention. Furthermore, although FIG. 2 shows two chambers on the downward side and two chambers on the upward side, one or more chambers may be used on each path to and from the containment vessel without departing from the scope of invention. Finally, note that the containment vessel itself may function as a chamber without departing from the scope of the invention.

FIG. 1 shows the inlet port and exhaust port as being located at the top of the apparatus, but the inlet port and/or the exhaust port may also be positioned along the wall instead of on the top of their respective chambers without departing from the scope of the invention.

Referring now to FIG. 1, an embodiment of a particulate extraction apparatus 100 may thus be seen. The apparatus 100 may be comprised of three sections 120, 140, and 160. The uppermost sections 120 and 140 may each contain two chambers arranged horizontally to one another but without communication for flue gas flow therebetween. The lowermost chamber 160 may serve to span the apparatus from left wall to right wall and connect vertically with each if the chambers in section 140. This arrangement will be described in more detail presently. The lowermost section 160 functions both as a chamber and as a containment vessel for collecting waste for removal. Removal may be accomplished by allowing sludge and other removed matter to flow out of the apparatus through the drain 180. An inspection port 185 may be provided to permit maintenance personnel to enter the section if desired. The uppermost section 120 may contain an initial chamber to receive the flow 105 of flue gases and a final chamber to exhaust the flow 107 of cleaned flue gasses. The uppermost section 120 may have attached thereto two spray lines 122, 124, to flush and clean their respective chambers. Similarly, the intermediate section 140 may also have attached thereto two spray lines 142, 144. The lowermost section 160 may also have two spray lines 162, 164 attached although it may comprise only a single chamber. As shown, the apparatus may thus comprise five chambers, each chamber having a water source connected thereto. Each spray line may have a nozzle internal to the chamber that may disburse the water in order to increase the area of water contact within the chamber. This operation may flush, if necessary, any particulates adhering to the walls of the chamber, so that they may fall as by gravity through chambers below to be collected at the base of the apparatus 100 for subsequent removal.

Referring now to FIG. 2, a cross-section of the apparatus 100 may be shown to illustrate an arrangement of chambers and their proportions. According to FIG. 2, a flow of flue gas entering the apparatus 100 may be directed through a plurality of chambers, each of which is designed to alter the volume of the flue gas and thus change its velocity. Each chamber may have a baffle (212, 222, 242, 252) therein to cause turbulence and thus break up any laminar flow of the gas along the walls of the chamber. The baffles 212, 222, 242, 252 may also serve to guide the flow of flue gas along a tortuous path through the apparatus 100.

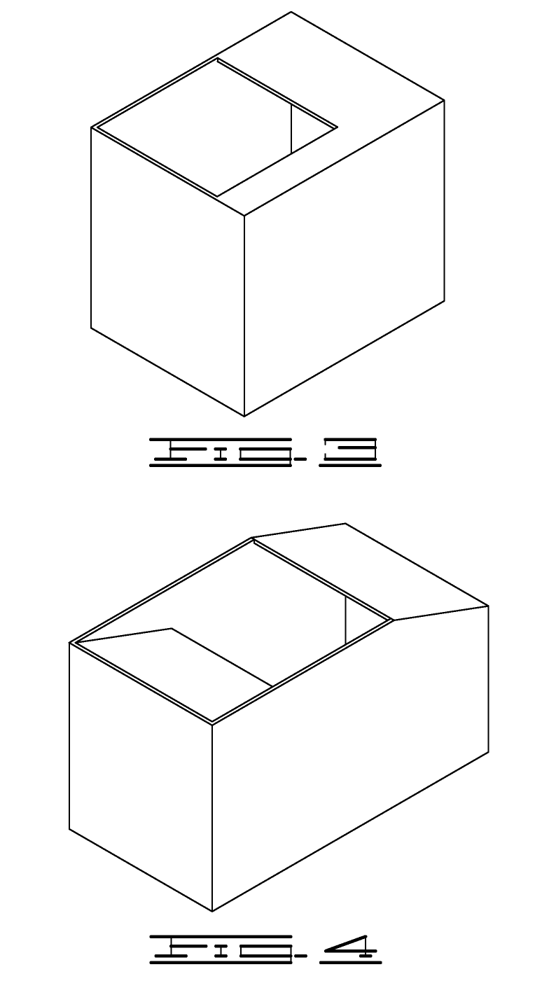

To better understand the invention, each chamber will be discussed below in detail. For explanatory purposes, each chamber may be viewed as basically a rectangular box, although in practice each chamber may be of any size or shape. In the embodiment shown, five chambers are configured with two chambers on the input portion 210 and 220, a bottom chamber 230, and two chambers on the output portion 240 and 250. FIGS. 3 through 7 show more details of the chambers. The input port of each chamber may be round, square, rectangular, or any practical shape as needed to best transmit the flue gases through the inventive device.

The first chamber 210, or initial chamber, may be designated the 50% velocity chamber. It may initially receive the flow of flue gases through its inlet port and direct the flow through its outlet port 216. The area of the inlet port may be preferably equivalent to the area of an exhaust pipe coming from the combustion source, whether it is an incinerator, a diesel engine, or other source of carbon product combustion. The maximum horizontal cross sectional area of the chamber may be two times the area of the inlet port, thus creating a 50% reduction in velocity. As shown in FIG. 3, it may be constructed as a rectangular box with an open bottom. The open bottom may set directly on top of the second chamber 220, designated as the first 33.33% velocity chamber. The inlet port for the second chamber 220 may be offset as much as possible from the output port of the first chamber 210 above in order to provide as tortuous path for the gases as possible.

The second chamber 220 may have a maximum cross-sectional area that may be three times greater than the area of the inlet port of the second chamber 220, thus reducing the velocity of the flue gases to 33.33% of their original velocity. The baffle 212 of the second chamber 220 may be angled downwardly at some angle downwardly from the horizontal, in this case, an angle of about 20°, to aid the particulates and condensate to migrate to the containment area in the bottom section 160 of the apparatus. The straight line distance from the lower end of the aforementioned baffle 212 to the top edge of the downwardly tapered right hand lid of the box is such that the area of the opening is the same as the original inlet port at the top of the chamber 220.

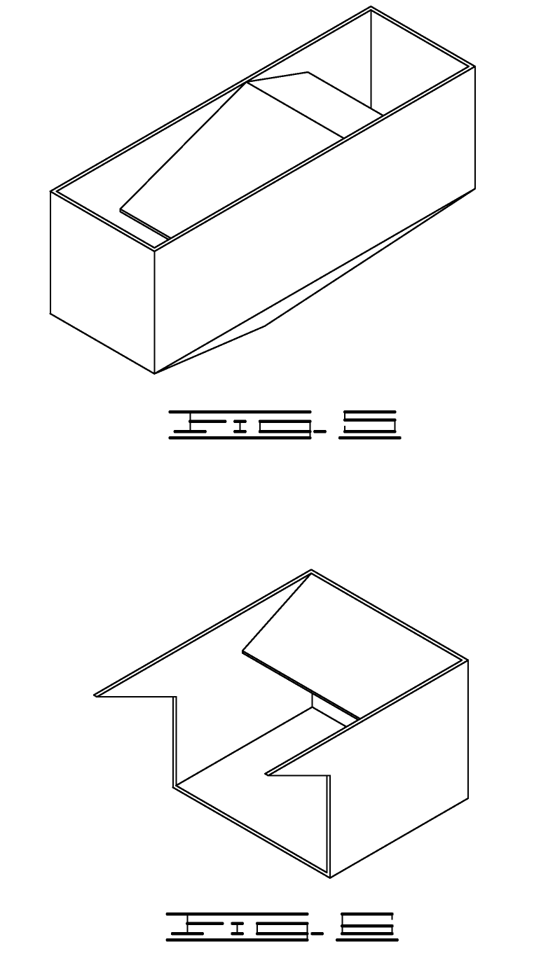

The bottom section 160 may contain the third chamber (FIG. 5), also designated as the 20% velocity chamber, which may be the largest chamber of the plurality of chambers. It may function as both a containment vessel and as an expansion chamber as well. It may have an outwardly tapered lower surface 232, 234 that may be connected to a drain 236 that is controlled by a valve 237, in order to facilitate draining the containments. Now referring to FIG. 5, the 20% velocity chamber may have two openings in its upper surface. The first opening may be its inlet port 238 on the left-hand end of the box. The inlet port 238 may have an area equal to the original inlet port in the first chamber 210 at the top of the device. Note that the baffle 222 of the left-hand end of chamber 230 may function as the bottom of the second chamber 220 above (as well as the bottom of the fourth chamber 240, as will be described presently). It may taper downwardly at an angle below the horizontal, at about 20° for example, to facilitate movement of the particulate and liquids down to the storage area at bottom of the third chamber. The cross-sectional area of the third chamber 230 may be five times greater than its inlet port 238, thus reducing the velocity of the flow of gases to 20% of the original velocity. In the 20% velocity chamber, the direction of flue gas flow may sequentially change from downwardly, to horizontally, and then to upwardly. On the right-hand end of the third chamber 230 may be an opening 239 that serves as an exit port from this chamber. The area of the exit port may also be equal to the area of the original inlet port 214 of the first chamber 210. The inner portion of right-hand end of the 20% velocity chamber may function as the bottom of the fourth chamber 240 above and may taper downwardly at some angle less than horizontal, i.e. about 20°, to aid in movement of the particulates and liquids down to the containment vessel.

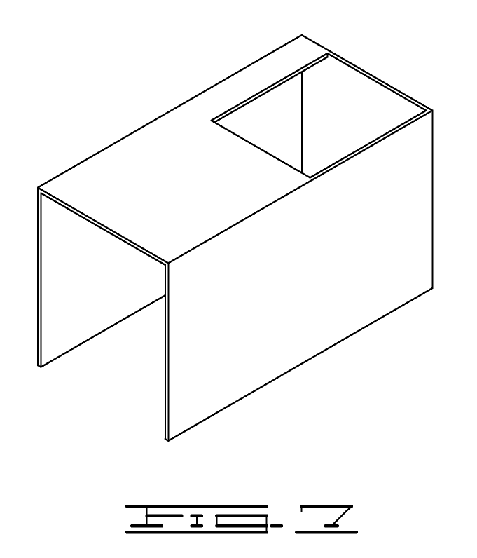

Referring again to FIG. 2, the fourth chamber 240, also designated as the second 50% velocity chamber, may be located on the right hand side and immediately above the fourth chamber. The bottom end of fourth chamber 240 may be open (FIG. 6), making it the inlet port into the second 50% velocity chamber function in communication with the exit port of the third chamber 230, i.e. the 20% velocity chamber. In the center of the fourth chamber 240, the maximum cross-sectional area may be equal to two times the inlet port area, which may reduce the velocity of the flue gasses to about 50% of their original velocity.

As a fabrication consideration, the left side of the fourth chamber 240 may be open as it fits against the side wall of the adjacent first 33.33% velocity chamber (i.e., the second chamber 220). The top may be partially closed with a slanted roof that defines an opening equal to the original inlet port area that serves as the exit port for the second 50% velocity chamber. The slope of the slanted roof may be about 20° to aid in moving particulates and contaminates to the storage area. Positioning the roof on the right-hand side of the chamber continues in maintaining the tortuous flow path.

Referring again to FIG. 2, immediately above the second 50% velocity chamber may be a second 33.33% velocity chamber. This chamber may have an open bottom and left side as it attaches directly to the second 50% velocity chamber below and to the first 50% velocity chamber to the left. The horizontal cross-sectional area in this chamber may be three times the area of the original inlet port, thus maintaining a 33.33% velocity through this chamber. From this point, the cleaned gases may pass out the exit port into the stack or exhaust. FIG. 7 illustrates this chamber in detail.

For the embodiment just described, the ratio of cross-sectional areas for adjacent velocity chambers may be either 2:3 or 3:2. Also the ratio of cross-sectional areas for velocity chambers in an adjacent level is just the opposite of this ratio. Thus if one level of chamber pairs has a ratio of cross-sectional areas of 2:3, then the next level of chamber pairs may have a ratio of cross-sectional areas of 3:2. When stacked in this manner, the sum of the ratios is always the multiplier of the bottom chamber, in this case, five. In this way, the amount of expansion of the flue gas may be varied and the path taken by the flue gas through the apparatus may be made more circuitous and tortuous.

In summary, the device illustrated above has ten changes in flow area, thus ten velocity changes from the inlet port through the outlet port. Using the inlet port area as one, then the multiples of area change are as follows: 1,2,1,3,1,5,1,2,1,3,1. Other combinations having different numbers of chambers may be used without departing from the scope of the invention. This huff and puff technique coupled with the large increases in chamber volume, plus the decreases in exhaust gas volumes (densities) due to temperature change and removal of particulate and condensation may cause large decreases in exhaust gas velocity and thus its ability to carry particulates. In addition, the 100% velocity openings between chambers may be offset to provide a tortuous path that also helps reduce the velocity of the gases.

The outside ends of the apparatus 100 can be semi-circular to help reduce the stress created by vibration on marine vessels, trains, trucks, etc. When necessary, the apparatus 100 may be configured to lay nearly horizontal for applications with limited head room.

Each chamber may contain at least one spray nozzle, which may spray water into the chamber at cleaning time to clean the shelves. An additional spray nozzle may be just above the drain opening, to spray a jet of water directly into the discharge opening to ensure that the drain 236 is open and to help transport it out of the apparatus. This is especially important when the trapped material is a heavy sludge. The particulate, acids, etc., may then be disposed of in a safe manner.

The apparatus 100 may be exposed to the ambient air without an insulated covering, in order to better radiate heat from its walls and thus enhance condensation of liquids in the flue gas. However, an outer cowl or covering (not shown) may be fabricated around the apparatus to serve as a conduit for a cooling air stream to be directed between the covering and the apparatus 100, thus enhancing the cooling process and improving heat transfer from the apparatus 100. Other means known to the art, such as cooling fins, radiators, or coils filled with a heat transfer fluid, may also used to enhance cooling of the outer walls of the apparatus 100 without departing from the scope of the invention.

From the foregoing, it will be understood by persons skilled in the art that a device for removing particulates from a dirty gas has been provided. The invention is relatively simple and easy to manufacture, yet affords a variety of uses. While the description contains many specifics, these should not be construed as limitations on the scope of the invention, but rather as an exemplification of the preferred embodiments thereof. The foregoing is considered as illustrative only of the principles of the invention. Further, because numerous modifications and changes will readily occur to those skilled in the art, it is not desired to limit the invention to the exact construction and operation shown and described, and accordingly all suitable modifications and equivalents may be resorted to, falling within the scope of the invention. Although this invention has been described in its preferred form with a certain degree of particularity, it is understood that the present disclosure of the preferred form has been made only by way of example and numerous changes in the details of construction and combination and arrangement of parts may be resorted to without departing from the spirit and scope of the invention.

We claim:

1. A particulate extraction apparatus for removing contaminants from a flue gas flowing in a direction from upstream to downstream, the apparatus comprising:
a plurality of chambers, each chamber having an inlet port, an outlet port, and at least one adjacent chamber, a first selected chamber being designated as an initial chamber to receive the flow of flue gas, a second selected chamber being designated as a final chamber to exhaust the flow of flue gas from the plurality of chambers, the chambers arranged in an ordered sequence with the initial chamber upstream from all other chambers and the final chamber downstream from all other chambers, the outlet of each chamber that is not the final chamber being in communication with the inlet of an adjacent downstream chamber.

2. The particulate extraction apparatus described in claim 1, wherein a maximum cross-sectional area of the each chamber is greater than a cross-sectional area of its outlet port.

3. The particulate extraction apparatus described in claim 1, wherein a maximum cross sectional area of the each chamber is greater than a cross-sectional area of its inlet port.

4. The particulate extraction apparatus described in claim 1, wherein a cross-sectional area of the inlet port of each chamber is equal to a cross-sectional area of the outlet port of that chamber.

5. The particulate extraction apparatus described in claim 1, wherein:
the apparatus comprises at least three chambers;
the initial chamber receives the flow of flue gas and directs the flow downwardly through the outlet port of the initial chamber in the direction of gravity;
an intermediate chamber receives the flow of flue gas through the intermediate chamber inlet port, conducts the flow of flue gas horizontally, and directs the flow of flue gas upwardly through the intermediate chamber outlet port; and
the final chamber receives the flow of flue gas from the intermediate chamber and directs the flow upwardly through the final chamber outlet port against the direction of gravity.

6. The particulate extraction apparatus described in claim 1, wherein the final chamber receives the flow of flue gas and directs the flow through the outlet port upwardly against the direction of gravity.

7. A particulate extraction apparatus for removing contaminants from a flue gas, the apparatus comprising:
one or more sections stacked vertically, each section containing a leftmost chamber and a rightmost chamber that do not communicate with each other, each chamber in the section having a top side, a bottom side, a port in the top side, and a port in the bottom side, the uppermost section receiving a stream of flue gas through the top side port of the leftmost chamber, the uppermost section delivering the stream of flue gas out of the top side port of the rightmost chamber; and
a containment vessel supporting the stacked sections with the bottom sides of the chambers in the lowest section in direct contact with a containment vessel top side, the containment vessel top side having a first containment vessel port in communication with the bottom side port of the leftmost chamber of the lowest section, the containment vessel top side having a second containment vessel port in communication with the bottom side port of the rightmost chamber of the lowest section;
wherein the apparatus conducts downwardly the stream of flue gas entering the top side port of the leftmost chamber of the upper section through all the leftmost chambers sequentially until the stream enters the containment vessel, horizontally from the first containment vessel port to the second containment vessel port, and thence upwardly through the rightmost chambers of each section sequentially to exit through the top side port of the rightmost chamber in the uppermost section.

8. The particulate extraction apparatus described in claim 7, wherein all ports comprising the apparatus have an equal cross-sectional area.

9. The particulate extraction apparatus described in claim 7, wherein the maximum cross-sectional area of each chamber is greater than the cross-sectional area of any port associated with the chamber, the flue gas entering each chamber being made to expand with a reduction in gas velocity, the expansion being caused by the difference in cross-sectional areas and allowing entrained particulates to be released from the flue gas.

10. The particulate extraction apparatus described in claim 9, wherein the port associated with the top side of the chamber is positioned at a first horizontal end of the chamber, and the port associated with the bottom side of the chamber is positioned at a second horizontal end of the chamber, so the path taken by the flow of flue gas through the apparatus is tortuous.

11. The particulate extraction apparatus described in claim 9, wherein the ratio of cross-sectional areas for the chambers in a section is 2:3.

12. The particulate extraction apparatus described in claim 11, wherein the ratio of cross-sectional areas for the chambers in an adjacent section is 3:2.
